(19) United States
(12) Patent Application Publication
(10) Pub. No.: US 2026/0082254 A1
(43) Pub. Date: Mar. 19, 2026

(54) METHODS, ARCHITECTURES, APPARATUSES, AND SYSTEMS FOR UE-ASSISTED SENSING CONFIGURATIONS COMPRISING ERROR HANDLING BEHAVIOR

(71) Applicant: InterDigital Patent Holdings, Inc., Wilmington, DE (US)

(72) Inventors: Ibrahim Hemadeh, Hemel Hempstead (GB); Arman Shojaeifard, London (GB); Yasser Mestrah, London (GB); Heggo Mohammad, London (GB); Paul Marinier, Brossard (CA); Ghyslain Pelletier, Montreal (CA); Fumihiro Hasegawa, Westmount (CA); Moon IL Lee, Melville, NY (US); Alain Mourad, Ascot (GB)

(21) Appl. No.: 18/886,601

(22) Filed: Sep. 16, 2024

(51) Int. Cl. H04W 24/10; H04L 1/00

(52) U.S. Cl. CPC H04W 24/10; H04L 1/00

(57) ABSTRACT

Procedures, methods, architectures, apparatuses, systems, devices, and computer program products are provided for integrated sensing and communications. Wireless transmit/receive unit (WTRU) methods and systems include receiving, from a wireless network, a sensing configuration for performing a sensing measurement task and an error configuration comprising an event trigger corresponding to the sensing configuration. The methods and system further include determining that the event trigger is satisfied and selecting, based on the event trigger, an error handling procedure from the error configuration.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

A device (e.g., a user equipment or a wireless transmit/receive unit) that is communicatively coupled to a wireless network may perform sensing-related measurements based on signals from the wireless network. During this process, errors may occur.

### SUMMARY

A wireless transmit/receive unit (WTRU) can be configured for integrated sensing and communication. For example, a WTRU can perform sensing tasks based on receiving signals from and optionally reporting measurements to a wireless network. In some embodiments, a WTRU receives at least one configuration from the wireless network and performs a sensing measurement based on the at least one configuration. However, there are many reasons why a WTRU may fail to properly receive or apply the configuration, or why the WTRU may fail to perform the sensing measurement based on the configuration. In accordance with certain embodiments of this disclosure, the WTRU receives an error configuration including an event trigger to provide failsafe responsiveness if a configuration or a sensing error occurs. In particular, the WTRU determines that an error has occurred (i.e., the event trigger has been satisfied) and selects, based on the specific error, a solution (i.e., an error handling procedure) from the error configuration. In some embodiments, the event trigger includes the configuration missing information, a failure to comply with the configuration, a failure to report a measurement based on the configuration, a failure to record a suitable measurement, or any combination thereof. In some embodiments, the error handling procedure includes sending an error report, applying another sensing configuration, reverting to a default configuration, retransmitting a missing report, buffering information of the sensing measurement, or any combination thereof. Based on the systems and methods of this disclosure, sensing measurement tasks performed by the WTRU may be made more robust to environmental conditions, WTRU hardware/software specifications, diverse sensing targets, or any combination thereof.

In accordance with certain embodiments of the present disclosure, methods and systems are provided for operating a WTRU. A method includes receiving, from a wireless network, a sensing configuration for performing a sensing measurement task and an error configuration comprising an event trigger corresponding to the sensing configuration. The method also includes determining that the event trigger is satisfied, and selecting, based on the event trigger, an error handling procedure from the error configuration.

In certain representative embodiments, the event trigger comprises at least one of missing information of the sensing configuration, a failure of the WTRU to comply with the sensing configuration, or a failure of the WTRU to communicate a measurement report based on the sensing measurement task to the network.

In certain representative embodiments, determining the event trigger is satisfied is based on a failure of the WTRU to comply with the sensing configuration, and the method further comprises obtaining measurements associated with the WTRU or with environmental information of the WTRU, and determining that the WTRU is unable to comply with the sensing configuration based on the obtained measurements.

In certain representative embodiments, the event trigger is based on a measurement of the sensing measurement task, and the measurement comprises at least one of an accuracy of a sensing measurement (e.g., an accuracy of any one or more sensing parameters of the measurement), a certainty of a sensing measurement, a confidence of a predicted measurement, a change in a channel response measurement, a measurement correlation, or an unidentified sensing profile. The methods and systems further comprise receiving a set of reference signals from the network, generating the measurement based on the set of reference signals, and determining that the event trigger is satisfied based on the measurement.

In certain representative embodiments, the error handling procedure comprises at least one of sending an error report comprising information indicating the determined event trigger, applying another sensing configuration based on the determined event trigger, reverting to a default sensing configuration, retransmitting a missing report, or buffering information associated with the sensing measurement task.

In certain representative embodiments, the error handling procedure comprises buffering information associated with the sensing measurement task, and the method further comprising sending a sensing buffer status report comprising at least one of an indication that the buffer status report is related to the sensing measurement task, a type of buffering associated with the buffer status report, a timing associated with the buffer status report, or a periodicity associated with the buffer status report.

In certain representative embodiments, the sensing configuration comprises a set of configurations, and each configuration of the set of configurations is associated with a respective set of targets, resources, or actions related to the sensing measurement task.

In certain representative embodiments, the methods and systems further comprise reporting error related information to the network, wherein the error related information comprises at least one of a retransmission configuration, another sensing configuration, or a default fallback configuration.

In certain representative embodiments, the methods and systems further comprise reporting information indicating the selected error handling procedure to the network, and receiving, from the network, an updated sensing configuration for performing the sensing measurement task.

In certain representative embodiments, the sensing configuration is a first sensing configuration, and the methods and systems further comprise reporting information indicating the selected error handling procedure to the network, wherein the reporting information comprises an indication of a second sensing configuration, receiving a negative acknowledgement associated with the second sensing configuration; and receiving a third sensing configuration.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows an illustrative approach for enquiring and sending a user equipment (UE) capability message;

FIG. 3 shows an illustrative example of UE obtaining sensing measurements using a received set of reference signals (RSs) and reporting the sensing measurements to the network;

FIG. 4 shows an illustrative example of UE indicating to the network to switch to a configuration and receiving an acknowledgement (ACK) from the network;

FIG. 5 shows an illustrative example of UE indicating to the network to switch to a configuration and receiving a negative acknowledgement (NACK) and an updated sensing configuration from the network;

FIG. 6 shows an illustrative example of UE detecting and reporting an event trigger to the network and receiving an updated configuration from the network;

FIG. 7 shows an illustrative example of UE detecting an event trigger based on a measurement from a first received set of RSs, receiving an updated configuration, and performing the measurement from a second received set of RSs; and

FIG. 8 shows a flowchart of an illustrative method performed by a WTRU for handling errors.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

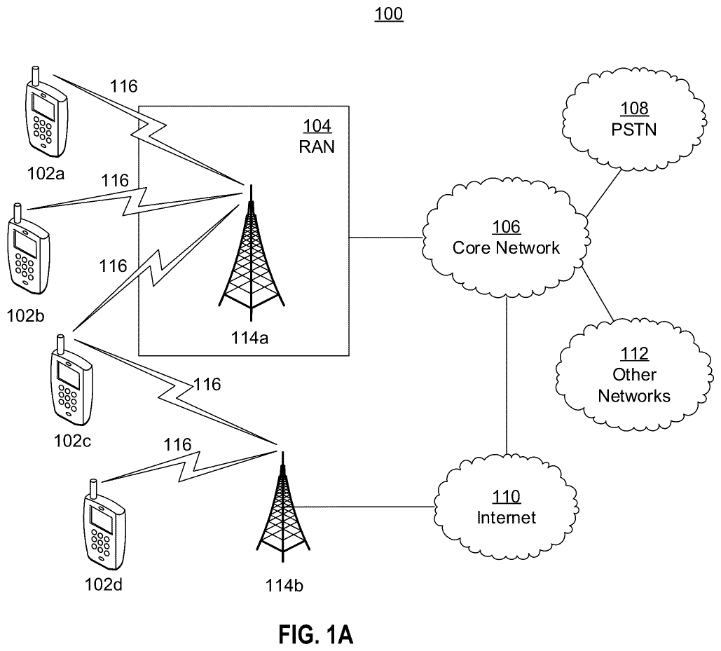

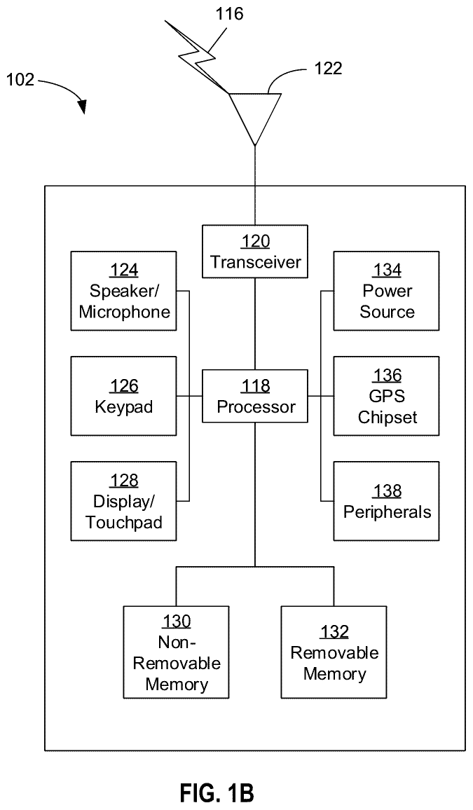

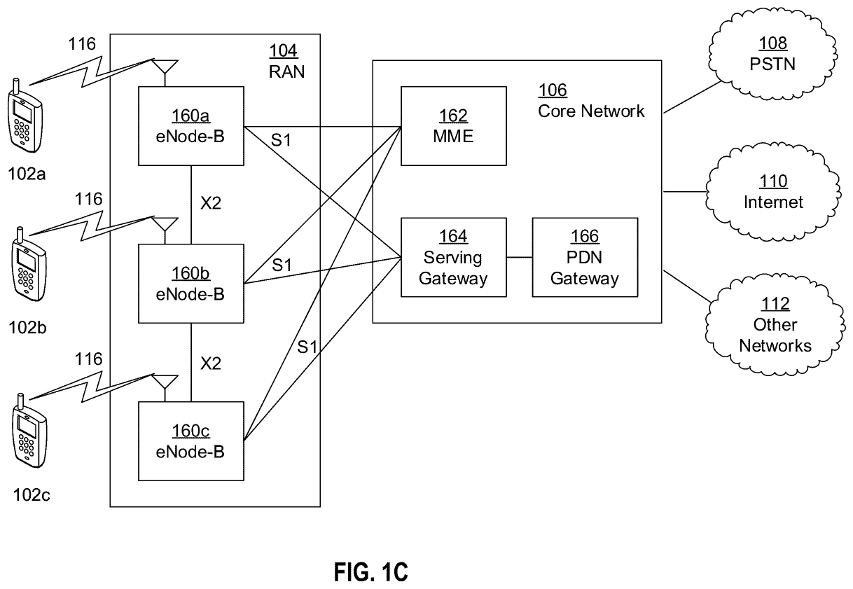

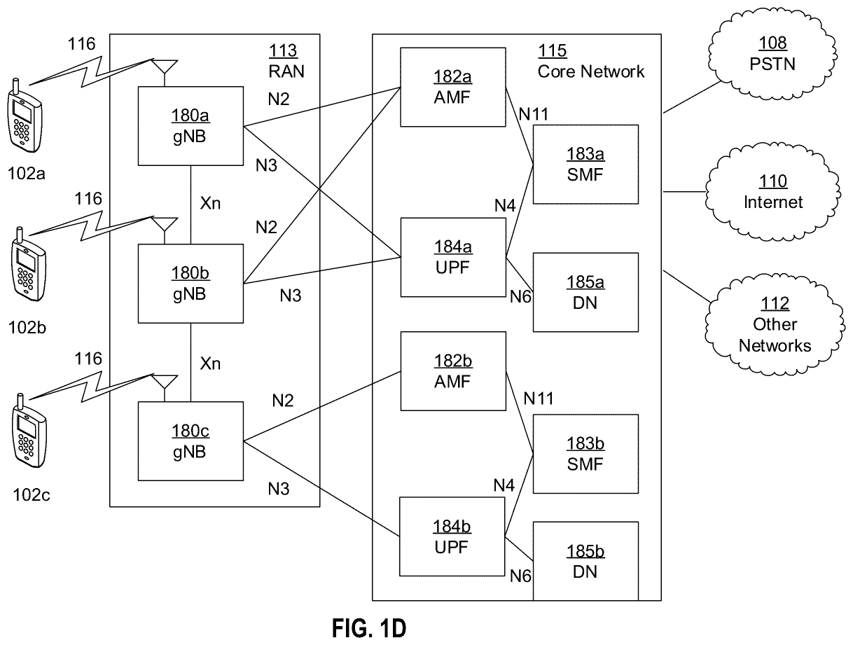

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

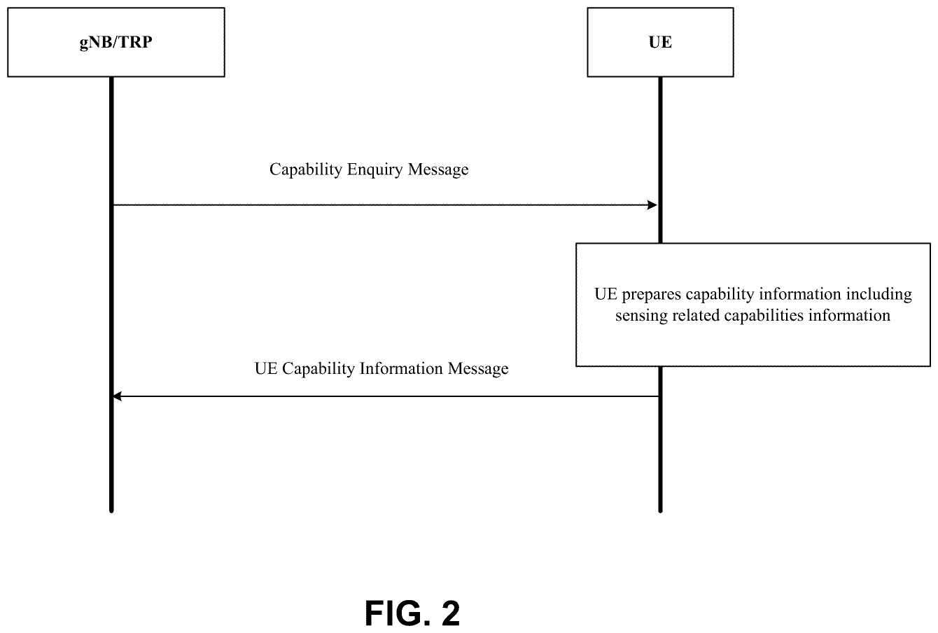

In certain embodiments of the present disclosure, including those described below at least in connection with FIGS. 2-7, the devices, systems, architectures, communication links, apparatuses, and other elements depicted in FIGS. 1A-1D may be used in connection with sensing configurations that support UE-assisted sensing measurement tasks and include error handling behavior.

Different sensing tasks may involve different events, measurements, and requirements. In one example, sensing may involve multiple sensing targets. Sensing multiple targets may require using a configuration that achieves a specific accuracy level or a set of sensing configurations that achieves multiple target accuracy levels. In another example, the sensing task involves continuous scanning and assessing of the sensing environment. This sensing transmission may require a set of different sensing configurations to detect changes, e.g., of sense targets. In another example, multiple sensing transmissions occur at once (e.g., multiple sensing measurements for multiple sensing targets). Handling multiple sensing transmissions may require expanded capabilities (e.g., expanded sensing configurations, payloads, or memory handling) for different sensing tasks and may lead to different configuration error events (e.g., which may include trigger events based on different error configurations) such as a failure to complete or continue with the sensing tasks (e.g., the accuracy falls below a threshold), a failure to receive or execute a given configuration (e.g., the network is unable to update the configuration or to comply with the new configuration), and/or a failure to report and acknowledge the sensing measurements and results (e.g., the network does not acknowledge the measurement report).

As used herein, a configuration error event may occur to an instance in which a WTRU determines that there is an error (e.g., determines that a trigger event is satisfied) based on an aspect of the WTRU's configuration (e.g., based on an error configuration). An occurrence of a configuration error event, which may include a trigger event, may indicate that the WTRU has determined that there is some error (e.g., corresponding to any of the trigger events described in this disclosure) related to a sensing measurement task. In response to a configuration error event, the WTRU may select and implement any one or more of the error handling procedures described in this disclosure.

Sensing may be performed with more than one configuration at the same time. For example, one configuration may be used, e.g., for tracking one or more targets, whereas another configuration may be used, e.g., for monitoring the sensing environment. The use of multiple configurations may lead to the occurrence of multiple configuration error events corresponding to the multiple configurations. In a scenario where the UE performs (or assists the network to perform) the sensing task through sensing measurements, a framework is needed to identify trigger events and define UE behaviours for the handling of the trigger events, thereby ensuring robustness of UE-assisted sensing operations. To achieve robust sensing, the UE may be configured to detect different trigger events and autonomously select a behaviour specific to each configuration.

Accordingly, to address such problems, a UE-assisted sensing framework where the UE, upon the triggering of a configuration error event, autonomously determines a corresponding error handling procedure is described herein. In some embodiments, the UE is configured to assist the network in performing sensing measurements with one or more sensing configurations. By using sensing measurements obtained from a set of RSs, the UE may obtain a set of measurements, validation metrics, error configurations, and/or event triggers. This information allows the UE to assist the network with the handling of a configuration error event. In some embodiments, the UE provides a preferred sensing configuration to achieve or maintain a specific sensing performance, e.g., by providing the network with sensing measurements, validation metrics, and event triggers to assist the network in making the decision to switch to, activate, or deactivate one or more configurations.

In some embodiments, the UE indicates or continues to indicate relevant information, e.g., instructions to switch to a different sensing configuration, to the network based on the triggering of a configuration error event. The network may update the sensing configuration and indicate this updated sensing configuration to the UE, e.g., via data center interconnect (DCI) or medium access control element (MAC-CE). Defining the error configuration, events triggers, and corresponding UE behaviours, as described in accordance with certain embodiments of this disclosure, results in increased robustness of the UE-assisted sensing framework compared to operation of a UE without defined errors.

In accordance with certain embodiments of the present disclosure, a method is provided as follows for configuring a UE (e.g., using a network) with a sensing configuration to assist with performing sensing measurements. The sensing measurements may include at least one of the following signals: sensing reference signals, e.g., channel state information reference signal (CSI-RS), positioning reference signal (PRS); sensing measurements; validation metrics, e.g., sensing task accuracy, certainty, Cramér-Rao lower bound (CRLB), or any combination thereof; a set of sensing configurations that support multiple sensing measurements, e.g., angle of arrival (AoA), time of arrival (TOA), or any combination thereof; preliminary sensing task information used for assisting a specific sensing task; and configuration error event triggers and corresponding behaviour.

In some embodiments, the configuration error event triggers include one or more of the following: a sensing measurement and/or metric falls below a specific threshold, the UE fails to receive a configuration (e.g., the UE receives a configuration with missing information), the UE fails to comply with the configuration, the UE fails to communicate the configuration, or a network request. The configuration error event triggers may be sent with the configuration to the UE or stored locally on the UE.

The UE may receive a first set of reference signals configured with a set of sensing configurations for performing one or more sensing tasks (e.g., tracking and/or monitoring) and obtain the sensing measurements (e.g., sensing measurements collected using the employed sensing configuration). Additionally, the UE may obtain one or more on-device measurements, e.g., software, hardware, and environmental measurements that can only be recorded at the UE.

The UE may use a current and/or previous sensing measurement or a sensing configuration application failure to identify event triggers, e.g., one or more events that are recognized by the UE to have occurred while performing at least one sensing measurements (e.g., based on at least one corresponding configuration).

Upon detecting an event trigger, the UE may autonomously (e.g., according to predefined logic of the UE) select an error handling procedure based on the determined event trigger and the received sensing configuration. The error handling procedure may include one or more of the following: sending an error report, e.g., including information associated with a specific error; applying a new or predefined configuration; falling back to a default configuration; or buffering the sensing report (e.g., buffering sensing information and informing the network that the device is buffering, as well as a buffer status).

In certain embodiments, applying the new or predefined sensing configuration comprises at least one of the following: the UE autonomously applies a new or predefined sensing configuration (e.g., another configuration, in contrast to an initial configuration) and indicates to the network the new sensing configuration; the UE requests a new sensing configuration; or the UE dynamically changes a set of sensing configurations (e.g., switch configuration confᵢⱼ to conf_{i′j′}, deactivate conf_{i″j″}, activate conf_{i′″j′″}) or a set of parameters (e.g., First Action taskₐ, Second Action task_{b}, Third Action task_{c}, or any combination thereof) within the current sensing configuration and indicates the changed sensing configuration and/or set of parameters to the network.

FIG. 2 shows an illustrative approach for enquiring and sending a UE capability message. As shown in FIG. 2, the WTRU operations may be performed by any of the WTRUs 102 of FIGS. 1A-D, and the gNB/TRP (i.e., transmission reception point) operations may be performed by any of the base stations 114 of FIG. 1A, the eNode-Bs 160 of FIG. 1C, or the gNBs 180 of FIG. 1D. In some embodiments, the UE uses this approach to inform the network of its sensing capabilities. The UE capabilities information message may include the sensing capabilities of the UE, where the sensing capabilities may include any one or more of: supported sensing modes, e.g., bistatic sensing, monostatic sensing, multistatic sensing, or any combination thereof; supported sensing measurements, e.g., AoA, ToA, time difference on arrival (TDoA), rich communication services (RCS), reference signal received power (RSRP), signal to noise ratio (SNR), or doppler information; supported sensing information, e.g., range, velocity, RCS profile, or any combination thereof; Channel response measurements, e.g., channel impulse response (CIR), packet data protocol (PDP); information about hardware related to sensing, e.g., sensing bandwidth, sensing frequencies, hardware computational complexity, or any combination thereof.

In accordance with certain embodiments of the present disclosure, sensing configurations may include a set of measurement events, triggers, UE behaviors related to indicating/requesting reconfiguration, or any combination thereof. In some embodiments, these UE behaviors are prompted in response to a failure or need for reconfiguration, e.g., when certain sensing measurement recorded with a current sensing configuration do not meet target properties (e.g., the sensing measurements are not suitable).

In some embodiments, the UE receives a sensing configuration from the network, e.g., via radio resource control (RRC), DCI or MAC-CE, or any combination thereof, for enabling the UE to assist the network in applying a new or predefined sensing configuration (e.g., switching between different configurations). The UE may receive a sensing configuration from the network based on a failure/need for reconfiguration (e.g., in response to a set of measurements obtained or triggering events detected).

According to certain embodiments of this disclosure, components of the sensing configuration are described as follows.

In certain embodiments, the sensing configuration includes information about the RS that can be used for performing at least one sensing measurement, including the type of RS (e.g., CSI-RS, PRS), RS resource allocation (e.g., time, frequency, space), periodicity (e.g., periodic, semi-periodic), resource element (RE) offset, quasi-co-location (QCL) information, transmission configuration indicator (TCI) states, bandwidth, symbol and comb offsets, periodicity, antenna ports, time window, or any combination thereof.

In some embodiments, the sensing configuration includes information regarding the radio and/or sensing measurement to be performed for the specific configuration, such as one or more of the following: sensing information, e.g., AoA, ToA, TDoA, RSRP, reference signal received power per resource element (RSRPP), Doppler, RCS; sensing measurements, e.g., range, velocity; channel responses, e.g., CIR, power delay profile (PDP); absolute/relative differences between different/consecutive CIR or PDP measurements and sensing range/velocity differences; statistical metrics, e.g., correlations between different measurements and gradients demonstrating change of channel correlation over multiple measurements; predictive measurement, e.g., based on AoA, ToA, RCS, CIR, PDP, RSRPs, SNR, or any combination thereof; or target profiles, e.g., RCS profiles.

In certain embodiments, the sensing configuration includes validation metrics. Examples of validation methods include thresholds associated with radio and sensing measurements, e.g., threshold of range accuracy, velocity accuracy, SNR, reference signal received power per resource element per path (RSRPP), correlation, or confidence/integrity of a predictive measurement.

In some embodiments, the sensing configuration includes a set of sensing configurations, where each configuration of the set may be associated with a set of targets, resources, and actions. The set of sensing configurations may further include any one or more of the following: sensing configuration labels/IDs, e.g., conf₁₁ for performing sensing measurement 1 and conf₁₂ for performing sensing measurement 2; specific RS configurations, e.g., antenna ports, TCI states, time/frequency resources allocation, periodicity type (e.g., periodic, semi-periodic); or sensing measurements/durations.

In certain embodiments, the sensing configuration includes sensing assistance information for a specific sensing measurement. This assistance information may be associated with the sensing target or targets, e.g., target ID, available scatterers type (e.g., environmental objects, clutter), angles (e.g., AoA), time (e.g., ToA), power (e.g., RSRP), profile (e.g., RCS), relevant channel responses (e.g., multipath components, CIR). In other embodiments, the assistance information may be directed towards the specific area, e.g., available targets ID, angle (e.g., AoA), time (e.g., ToA), power (e.g., RSRP), profile (e.g., RCS), relevant channel responses.

In some embodiments, the sensing configuration includes at least one error configuration. That is, the WTRU may receive a sensing configuration and the WTRU may receive an error configuration (which may be included within the sensing configuration, or which may be received separately). The error configuration may include error event triggers (e.g., event triggers, for short), which may include a set of events that are recognised as errors (e.g., based on conditions provided in configuration or validation parameters) and may require activating/deactivating a specific sensing and/or error configuration if the event trigger is determined to have been satisfied. The set of event triggers may include at least one of the following event triggers: UE fails to perform sensing tasks, e.g., a specific measurement falls below a specific threshold; UE fails to receive the sensing configuration, e.g., the received sensing configuration is missing information, there is a time out associated with receiving the full payload associated with the sensing configuration, or the UE requests another configuration but it is not fully received; UE fails to comply with the sensing configuration; UE fails to communicate the measurement report; or UE receives a network request, e.g., after transmitting a specific measurement or indication to the TRP, the UE may receive a new sensing configuration from the TRP.

In certain embodiments, the error configuration includes error-related information. For example, the error configuration may include retransmission configurations (e.g., the number of retransmissions, duration of timeout) and/or default fallback configurations (e.g., in the case of failure to communicate the measurement report). In some embodiments, retransmission configurations and/or default fallback configurations may also be included as part of an error handling procedure that is implemented in response to an event trigger of the error configuration being satisfied.

In some embodiments, the UE is configured by the network with a second sensing configuration which may include a fully updated configuration or an updated portion of the configuration, e.g., via RRC, MAC-CE, DCI. In some embodiments, the UE is configured with the uplink (UL) resources for sending reports corresponding to different sensing measurements and error configurations, including different trigger events. In one example, the UE may be configured to dynamically send the reports, e.g., via uplink control information (UCI), MAC-CE, or over RRC signalling using certain UL resources (e.g., physical uplink shared channel (PUSCH), physical uplink control channel (PUCCH)).

In some embodiments, UE uses the one or more active configurations to obtain radio and sensing measurements and validation measurements. For example, any of these measurements may constitute a set of measurements that can be used for detecting an event trigger (e.g., based on one or more measurement values crossing corresponding thresholds).

In some embodiments, the UE receives a first set of reference signals, e.g., RS, CSI-RS, or synchronized signal block (SSB), configured with a set of sensing configurations for performing specific sensing tasks. The UE may receive the set of reference signals with one or more sensing configurations (e.g., reference signals defined in the initial configuration) to perform sensing measurements and obtain the validation measurements. The UE may also perform sensing measurements for multiple targets, e.g., relying on assistance sensing information (e.g., tracking of multiple targets with different requirements) provided in the initial configuration.

In certain embodiments, the sensing configuration causes the UE to perform multiple sensing measurements using the allocated resources within the sensing time window, which may comprise a start and/or end sensing window time, a sensing duration, and information about the periodicity, as per the configuration.

According to certain embodiments of this disclosure, examples of measurements that the UE is configured to obtain are described as follows.

In one example, the sensing configuration causes the UE to collect angular, temporal and power measurements (e.g., AoA, ToA, TDoA, SNR, RSRP, RSRPP, RCS, or any combination thereof) during the defined time window and using the released resources. In another example, the UE obtains the channel responses (e.g., CIR, PDP).

In another example, the UE obtains from angular, time, and/or power measurements the sensing information of one or more targets, such as the range, velocity, or RCS profile.

In another example, the UE determines the set of validation metrics, e.g., the accuracy of sensing measurements (e.g., accuracy of range, velocity) obtained with one or more configurations and certainty values for the obtained measurements (e.g., certainty of AoA, ToA, TDoA).

In some embodiments, the UE obtains and stores the change or average of a specific measurement over multiple measurements obtained with one or more configurations. For example, the UE may compute the absolute or relative differences between the obtained measurements. In another example, the UE computes the absolute or relative differences between the angular, delay, and power measurements (e.g., AoA, ToA, TDoA, RSRP, RSRPP, SNR, RCS, or any combination thereof) as well as the differences in sensing information (e.g., range, velocity, RCS profile), validation measurements (e.g., sensing accuracy), and channel responses (e.g., CIR, PDP). The UE may also determine the average of these measurements as obtained over a specific time window or over a specific number of measurement occasions.

In certain embodiments, the UE determines statistical metrics based on the obtained measurements recorded using one or multiple configurations. In one example, the UE determines the correlation between multiple measurements (e.g., angular, delay, power, RCS, CIR, PDP) obtained over a specific time window or a specific number of measurement occasions. In another example, the UE determines the slope corresponding to the change of a specific parameter, e.g., using a gradient measurement to determine the direction and rate of change.

In some embodiments, the UE obtains a set of predictive measurements based on a set of obtained measurements from previous and/or current measurements using one or more sensing configurations. For example, the UE may determine a set of predicted measurements, such as the predicted radio measurements (e.g., AoA, ToA, TDoA, SNR, RSRP, RSRPP, RCS, or any combination thereof) and sensing measurements (e.g., range, velocity, doppler), as well as the set of measurement accuracies.

In certain embodiments, the UE also obtains UE-based measurements (e.g., hardware, application-level, and surrounding measurements, e.g., that can be recorded at the UE without information from RSs). For example, the UE-based measurements may include the device temperature, device memory information, device processing information, maximum device buffer capacity, battery level, application level-related information, environmental information (e.g., temperature), or any combination thereof.

In accordance with certain embodiments of the present disclosure, the UE may use sensing measurements obtained using one or more sensing configurations in order to detect an event trigger of an error configuration. For example, the event trigger may include the current sensing configuration being unable to provide sensing measurements that meet a certain quality, e.g., a specific threshold is not met or a recorded RCS profile is unidentified. That is, the event trigger may include determining that the sensing measurements are not suitable.

In one example, the sensing configuration causes the UE to perform measurements (e.g., AoA, TDoA, ToA, RSRP, RSRPP, SNR, RCS, doppler, or any combination thereof) for sensing across one or more measurement occasions using one or more respective sensing configuration. After receiving the RS resources and an indication to start performing sensing measurements, the UE may determine a set of validation metrics for those measurements, e.g., where the validation metrics are used to determine if sensing requirements associated with the sensing measurements are satisfied. The UE may use the obtained sensing measurements and validation metrics to identify one or more event triggers, which may be provided by the network as part of the error configuration. These event triggers allow the UE to trigger a request or a report to the TRP to switch, activate, and/or deactivate one or more new/predefined configurations when the current one or more configurations cannot meet a certain quality.

In certain embodiments, the event triggers include any one or more of the following: accuracy of a sensing measurement or a measured sensing parameters (e.g., range, velocity, location) falls below a specific threshold (e.g., thres₁); certainty of a specific sensing measurement (e.g., AoA, ToA, SNR, RSRPP, RCS) falls below a specific threshold (e.g., thres₂); confidence/integrity of a predicted measurement falls below a specific threshold (e.g., thres₃); change in a channel (e.g., gradient of deltas of multiple channel CIRs) rises above a specific threshold (e.g., thres₄); a sensing profile (e.g., RCS profile) of a specific target is unidentified; a sensing measurement affecting the sensing accuracy (e.g., RSRP, SNR) goes below a specific threshold; a sudden change in a sensing information (e.g., change in range and velocity) rises above a specific threshold; one or more UE-based readings (e.g., high device temperature, device memory at capacity, device full-capacity processing reached, device buffer at capacity, application level-related information, environmental information (e.g., temperature, humidity)) are above/below a specific threshold; a configuration-related error is detected; or a network request is received.

In one example, when the TRP fails to change a sensing and/or error configuration after a UE indication, request, or report (e.g., to switch, activate, and/or deactivate a new or predefined configuration), or the UE doesn't receive an ACK/NACK (i.e., acknowledgement/negative acknowledgement) or a corresponding response after the specific indication, request or report, then the UE reports the failure of the TRP to change its sensing and/or error configuration to the TRP as part of the selected error handling procedure of reporting the event trigger and, optionally, information related to the event trigger.

In accordance with certain embodiments of the present disclosure, the UE may report sensing measurements and other relative measurements, e.g., measurements obtained with the active or released configurations/resources. In one example, the UE reports or indicates to the TRP that a specific event trigger has occurred, and the UE requests or indicates a change in the sensing and/or error configuration, e.g., via UCI, MAC-CE, RRC. The report may include details about the event that occurred, e.g., the threshold is obtained, the RCS profile is unidentified. The indication in the report may include a set of parameters that need to be changed in the sensing and/or error configuration, e.g., time/frequency resources.

In another example, the UE sends a report to the network that includes a set of sensing measurements and relevant information obtained using the received set of reference signals with one or more sensing configurations. This report may include one or more of the following: sensing measurements (e.g., AoA, ToA, TDoA, RSRP, SNR, RSRPP, RCS, doppler, or any combination thereof) obtained from one or more configurations; sensing information determined using the sensing measurements, e.g., target range, location, velocity, RCS profile; set of validation metrics, e.g., including a set of thresholds associated with measurements; associations between each target and the one or more sensing configurations (e.g., the target is associated with the configuration used to obtain measurements of the target); associations between each target, the set of sensing measurements, sensing information, and relevant validation metrics based on the one or more sensing configurations; the set of UE-based measurements (e.g., hardware, application-level and surrounding measurements); or any other suitable sensing measurements (e.g., including any other sensing measurements defined in this disclosure).

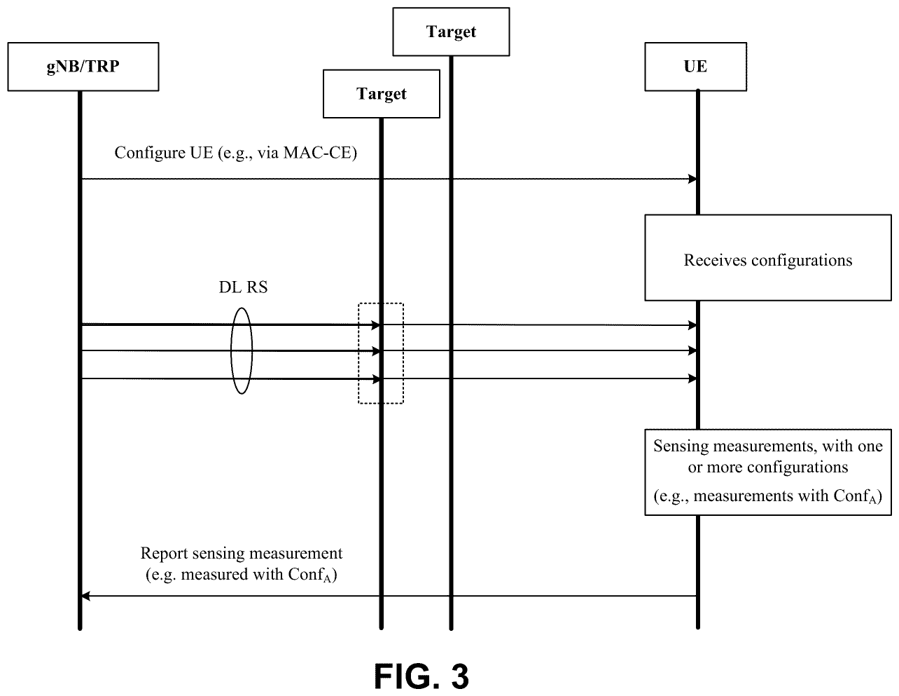

FIG. 3 shows an illustrative example of UE obtaining sensing measurements using a received set of RSs and reporting the sensing measurements to the network, in accordance with certain embodiments of this disclosure. As shown in FIG. 3, the WTRU operations may be performed by any of the WTRUs 102 of FIGS. 1A-D, and the gNB/TRP operations may be performed by any of the base stations 114 of FIG. 1A, the eNode-Bs 160 of FIG. 1C, or the TRPs 180 of FIG. 1D. In certain embodiments, the UE performs sensing measurements using a first set of RSs with one or more sensing configurations, e.g., Conf_A. Based on these measurements, the UE may prepare and report a first sensing report to the TRP.

In other embodiments, the UE sends a second report after performing a second set of measurements with an updated sensing configuration, e.g., in response to an error handling procedure that includes a request by the UE for another sensing configuration or causes the TRP to apply another sensing configuration. The second report may include one or more of the following: updated sensing measurements obtained with the new one or more sensing configurations; updated sensing information; updated validation metrics, especially for those that went below a specific threshold in a previous one or more configurations; associations between the updated measurements, validation metrics and the new one or more sensing configurations; or any combination thereof.

In some embodiments, the UE sends the sensing measurements report over an uplink control or data channel, e.g., PUCCH and/or PUSCH. For example, the UE may send the measurement report over PUSCH and send decoding information over PUCCH. In another example, the UE sends the sensing report over PUCCH only, and in another example the UE sends the sensing measurement report over PUSCH only. In other examples, the UE sends the sensing measurement report dynamically, e.g., over UCI, MAC-CE, or RRC signalling.

In some embodiments, the UE reports or indicates to the TRP that a specific event trigger has occurred and, based on the event trigger, requests/indicates a change in the sensing and/or error configuration, e.g., via UCI, MAC-CE, RRC. The report may include details about the event that occurred, e.g., the threshold was obtained, or the RCS profile was not identified. The indication may include a set of parameters that need to be changed in the sensing and/or error configuration, e.g., time/frequency resources.

In accordance with certain embodiments of the present disclosure, the UE may obtain a set of sensing measurements, validation metrics, and other UE-based measurement. Based on these measurements, the UE may detect that an event has occurred (e.g., the UE may determine that the event trigger has been satisfied) and select an error handling procedure (e.g., which may cause the UE to indicate another sensing configuration that has been or will be applied, report the event, and/or request the network for a reconfiguration).

In one example, the UE may use the obtained measurements and the information relevant to an error configuration, e.g., validation metrics and/or UE-based measurements, to autonomously select a specific sensing configuration, or to suggest deactivating, activating and/or switching one or more new or predefined sensing configurations. The UE may report or indicate to the TRP that a specific event trigger has occurred (e.g., via UCI, MAC-CE, RRC), which includes the preferred action, e.g., switching, activating and/or deactivating one or more configurations/resources. The TRP may then send an indication whether the UE's indication has been received and employed, e.g., ACK or NACK.

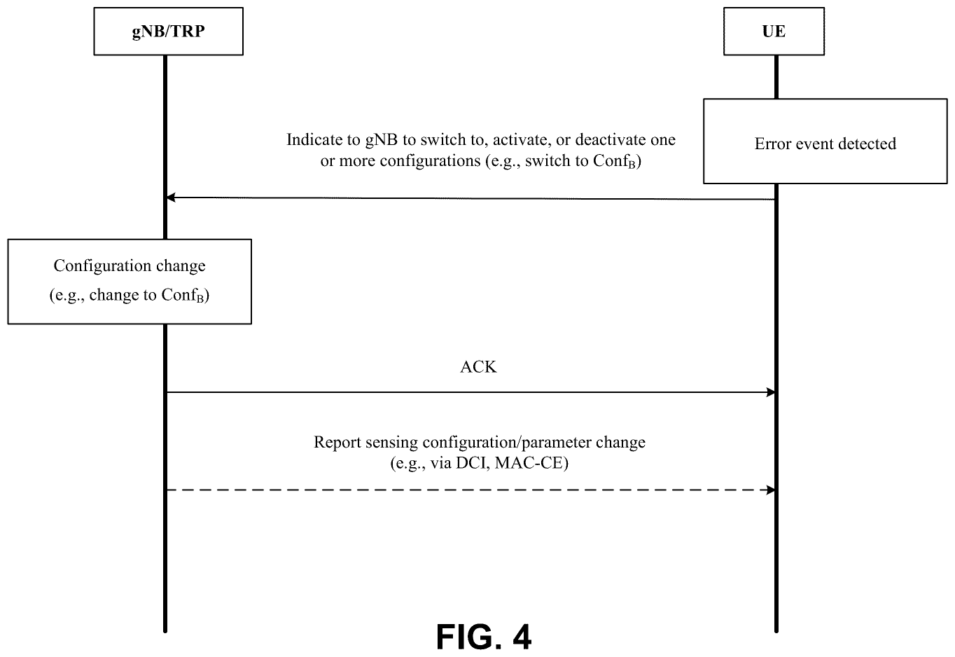

FIG. 4 shows an illustrative example of UE indicating to the network to switch to a predefined configuration and receiving an acknowledgement (ACK) from the network, in accordance with certain embodiments of this disclosure. As shown in FIG. 4, the WTRU operations may be performed by any of the WTRUs 102 of FIGS. 1A-D, and the gNB/TRP operations may be performed by any of the base stations 114 of FIG. 1A, the eNode-Bs 160 of FIG. 1C, or the TRPs 180 of FIG. 1D. After the UE detects an event trigger based on an error configuration, it may select and implement an error handling procedure as follows. The UE may autonomously switch to a specific sensing configuration and may indicate that specific sensing configuration to the TRP (e.g., to cause the TRP to switch a property of a RS transmission based on that sensing configuration). For example, the UE may indicate a switch to Conf_{B}. Then, the TRP then may send an ACK and the updated parameters of the sensing configuration to the UE.

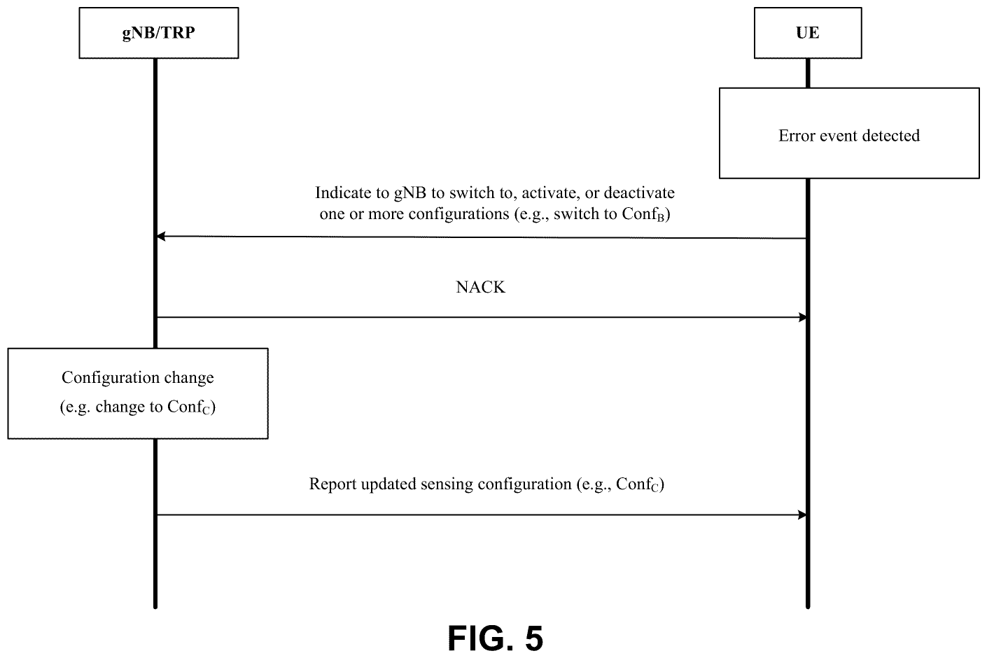

FIG. 5 shows an illustrative example of UE indicating to the network to switch to a predefined configuration and receiving a negative acknowledgement (NACK) from the network along with an updated sensing configuration, in accordance with certain embodiments of this disclosure. As shown in FIG. 5, the WTRU operations may be performed by any of the WTRUs 102 of FIGS. 1A-D, and the gNB/TRP operations may be performed by any of the base stations 114 of FIG. 1A, the eNode-Bs 160 of FIG. 1C, or the TRPs 180 of FIG. 1D. The UE may indicate to the TRP to apply a new or predefined one or more sensing configurations or to update specific parameters in the sensing configuration after determining that an event trigger of an error configuration has been satisfied. However, the TRP may not employ the indicated sensing configuration; thus, the UE may receive a NACK or optionally a NACK with the updated sensing configuration, e.g., Conf_{C}.

In some embodiments, as part of an error handling procedure, the UE suggests or indicates switching a sensing configuration, e.g., applying a new or predefined sensing configuration (e.g., either of which may be described as another configuration, with respect to a current configuration). For example, the UE may indicate to switch the current sensing configuration from confᵢⱼ to conf_{ij′}. As another example of an error handling procedure, when a validation metric (e.g., accuracy of a measured sensing parameter of a sensing target) falls below a specific threshold, the UE may suggest or indicate switching to a different sensing configuration to improve that specific metric, e.g., to meet a certain sensing quality (e.g., range accuracy, velocity accuracy, and/or location accuracy). As another aspect of the error handling procedure, the UE may also suggest or indicate switching to a different sensing configuration when the certainty of a specific sensing measurement (e.g., certainty of AoA, ToA, SNR/RSRPP and/or RCS profile) falls below a specific threshold.

In other embodiments, the UE selects an error handling procedure and therefore requests activation of a specific sensing configuration, e.g., activation of conf_{i′j′}, to perform sensing measurements. For example, the UE may request activation of a specific sensing configuration when the change of channel responses (e.g., CIR, PDP) rises above a specific threshold, e.g., the gradient of deltas of two or more channel response measurements [CIR(1), CIR(2), . . . , CIR(N)] exceeds a specific threshold. In one example, the UE may request switching between UL/DL sensing transmissions as part of the error handling procedure.

In some embodiments, the UE requests deactivation of at least one sensing measurement, e.g., by deactivating a transmitted reference signal and corresponding allocated resources. The request for deactivation may be transmitted via UCI, MAC-CE or RRC signalling.

In some embodiments, UE operations (e.g., which may be referred to as UE behavior) include a combination of two or more actions. For example, the UE operations may include a first action, action₁ (e.g., switch configuration confᵢⱼ to conf_{i′j′}), a second action, action₂ (e.g., deactivate conf_{i″j″}), and a third, action action₃ (e.g., activate conf_{i′″j′″}).

In one example, the UE requests termination of one or more sensing measurements, e.g., by terminating the transmitted reference signal and corresponding allocated resources (e.g., time, frequency, space, or any combination thereof). The request for termination may be transmitted via UCI, MAC-CE, or RRC signalling. In some embodiments, as part of an error handling procedure, the UE may determine that it cannot proceed with the sensing measurements due to one or more UE-based measurements (e.g., hardware, application level, or environmental measurements) and may send a termination request to the TRP based on the sensing measurement or a failure to comply with a sensing configuration.

In some embodiments, as part of an error handling procedure, the UE sends a report to the TRP after detecting an event trigger, e.g., via UCI, MAC-CE, RRC. The report may comprise one or more of the following: obtained sensing measurements (e.g., AoA, ToA, RSRPP, RCS); sensing metrics (e.g., range, velocity); one or more validation metrics relevant to the event (e.g., threshold was obtained, RCS profile was not identified); or error configurations.

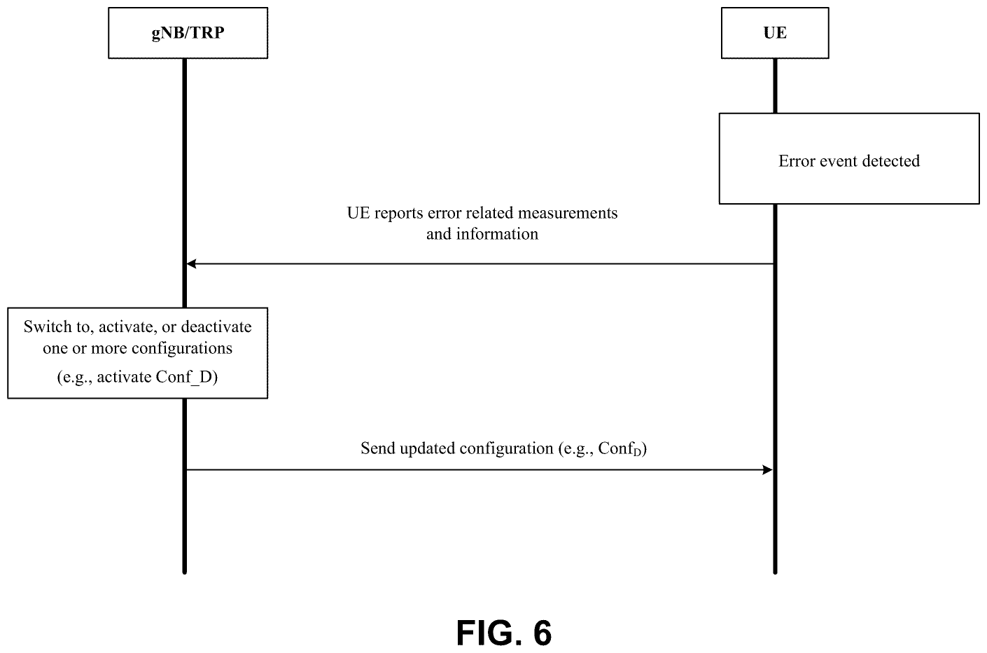

FIG. 6 shows an illustrative example of the UE detecting and reporting an event trigger to the network and receiving an updated configuration from the network, in accordance with certain embodiments of this disclosure. As shown in FIG. 6, the WTRU operations may be performed by any of the WTRUs 102 of FIGS. 1A-D, and the gNB/TRP operations may be performed by any of the base stations 114 of FIG. 1A, the eNode-Bs 160 of FIG. 1C, or the TRPs 180 of FIG. 1D. The error event report sent by the UE may additionally include a preferred configuration update. By sending this report, the UE may cause the TRP to receive the error event report (including the preferred configuration), implement the preferred configuration, and send the updated configuration (e.g., Conf_{D}) back to the UE.

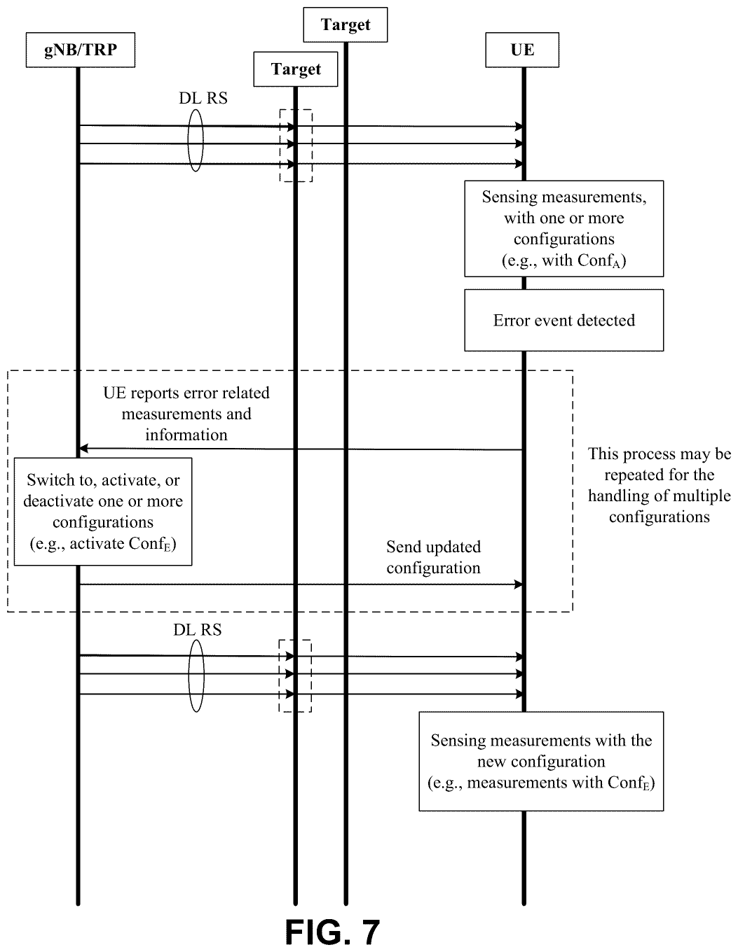

FIG. 7 shows an illustrative example of the UE receiving an indication of an updated configuration and obtaining a second set of sensing measurements using a second set of received RSs, in accordance with certain embodiments of this disclosure. As shown in FIG. 7, the WTRU operations may be performed by any of the WTRUs 102 of FIGS. 1A-D, and the gNB/TRP operations may be performed by any of the base stations 114 of FIG. 1A, the eNode-Bs 160 of FIG. 1C, or the TRPs 180 of FIG. 1D. The UE may perform sensing measurements using one or more RS received with a specific sensing configuration, e.g., Conf_{A}. The UE may detect an event trigger of an error configuration and, as part of an error handling procedure selected based on the event trigger and/or the error configuration, report the error and request changing of the sensing configuration. In one example, the UE reports the error to the TRP and the TRP sends the updated sensing configurations, e.g., Conf_{E}. In another example, the UE autonomously switches to another sensing configuration or changes parameters and indicates the change to the TRP, e.g., by requesting the TRP change to Conf_{E}. As part an error handling procedure, the UE may receive an indication that the sensing configuration has been updated as per the report/request/indication sent by the UE. This indication may include one or more parameters of the sensing configuration that are updated, one or more sensing and/or error configurations employed/changed, as well as one or more measurements to be performed (e.g., AoA, ToA, TDoA, RSRP, doppler, RCS, or any combination thereof) and validation metrics to be obtained. After the updated sensing/error configurations/resources are released, as part of an possible error handling procedure, the UE may receive a second set of RSs and perform a second set of sensing measurements based on the second set of RSs. The UE may obtain multiple sensing measurements if the updated sensing configuration (e.g., Conf_{E}) causes the UE to do so.

In one example, the UE may receive the second sensing and/or error configuration over RRC, MAC-CE, or DCI. In another example, the UE may receive a change in one or more parameter in the sensing and/or error configuration, e.g., via MAC-CE, or DCI.

In accordance with certain embodiments of the present disclosure, representative error configurations and event triggers, including categories of these errors and events, are provided as follows.

In some embodiments, the UE fails to receive the sensing and/or error configuration. In one example, the UE detects an event trigger (e.g., failure to perform a sensing task), which, as part of an error handling procedure, triggers the application of a new, another, or a predefined sensing configuration. The TRP may send a new or predefined sensing configuration but the UE may not receive it, e.g., the event trigger may be a failure to receive the updated/new sensing configuration. Illustrative error handling procedures based on the UE failing to receive a sensing configuration are provided as follows.

For one error handling procedure, the UE may employ a retransmission mechanism, where it may attempt to retransmit the error reporting N_{error_retransmit} times, wherein a predefined period of time is defined for each retransmission. In one example, the UE retransmits the error report and doesn't receive the reconfiguration from the TRP. The UE then waits a specific time Tᵣₑₜᵣₐₙₛₘᵢₜ before retransmitting the report again. This retransmission may repeat for N_{error_retransmit} times. During the retransmitting, the UE may either continue to perform measurements using the set of RS received, it may perform a reduced set of measurements, or it may entirely stop performing measurements.

For another error handling procedure, if the UE doesn't receive the new configurations after multiple retransmissions (e.g., multiple error event reporting retransmission fails N_{error_retransmit} times), the UE may apply a time-out option (e.g., stop an operation based on the operation exceeding a time limit). For example, the time-out condition may be defined based on the total number of retransmissions multiplied by the time duration for each retransmission (e.g., N_{error_retransmit}×Tᵣₑₜᵣₐₙₛₘᵢₜ).

For another error handling procedure, after the preconfigured time-out has passed, the UE may proceed by performing one or more of the following actions: sending an error report, e.g., logging error to the TRP and notifying it about the failure to receive the new sensing configuration; proceeding with sensing measurements using the received RS, and notifying the TRP that the sensing operation with the current sensing configuration/set of configurations will continue, e.g., with the same sensing configuration where the event trigger was detected; falling back to a predefined default sensing configuration and notifying the TRP about the fallback, e.g., switching back from a current sensing configuration (e.g., Conf_{B}) to a default sensing configuration (e.g., Conf_{default}) and notifying the TRP about this change; informing the network about the event trigger, e.g., indicating the event trigger to the network and including a preferred sensing configuration (e.g., a request for Conf_{C} over current sensing configuration Conf_{B} based on obtained error information); requesting termination of the sensing operation, e.g., requesting termination and optionally stopping performing measurements with the received RS; or determining a new sensing configuration.

For another error handling procedure, upon determination of a new configuration, the UE may indicate to the network that the UE has switched or will switch to the newly determined sensing configuration, or the UE may autonomously switch to the determined sensing configuration and, e.g., let the network detect the switch.

In some embodiments, any of the aforementioned error handling procedures may be combined. That is, an error handling procedure may include a sequence of procedures that may or may not be fully implemented based on the outcomes of each respective procedure.

In some embodiments, the event trigger occurs when the UE fails to comply with a received configuration. For example, the UE may obtain one or more UE-based measurements, such as hardware-based measurements, software-based measurements, and/or surrounding environmental information. As part of an error handling procedure, the UE may then receive a certain sensing configuration for performing sensing measurements. However, another event trigger may occur in which the UE may not be able to comply with the new sensing operation or the new set of sensing configurations based on one or more of the UE-based measurements (e.g., measurements available at the UE). For example, the UE may determine that it is at too high of a temperature to comply with a received configuration, and the UE may further indicate another configuration that is selected based on the recorded UE temperature.

To determine that an event trigger is satisfied, the UE may obtain different UE-based hardware or software measurements that affect the sensing operation. Such measurements include at least one of the following: device temperature, device memory information, device processing capacity availability, device buffer availability, battery level, application level-related information, CPU power, or hardware malfunction information/status.

As part of an error handling procedure, the UE may send an error report to the network when one or more of the following events occur: the temperature of the device exceeds a specific threshold; the device memory usage has reached a specific level, e.g., exceeds a specific threshold; the device processing capacity is utilized above a specific threshold; the device buffer availability is below than a specific threshold; the device battery is below a specific threshold; the device CPU overload exceeds a specific threshold; an application-level indication, e.g., application-level permissions to access some sensing measurement data; or a hardware malfunction (e.g., sensor failure) is detected at the UE.

The UE may obtain environmental related information through one or more on-device sensors (e.g., hygrometer, thermometers) or though alternative methods (e.g., third party services or other available radio access technologies) (e.g., to determine whether an event trigger is satisfied). In some embodiments, the UE may obtain different weather conditions that have a direct or indirect impact on the sensing operation, e.g., reducing sensing accuracy to account for the conditions introducing attenuation, reflection, refraction, and/or backscattering to the sensing signals.

In one example, the weather information may include precipitation. In particular, the weather information may include one or more different types of precipitation, e.g., rain, hail, or snow. This information may include the severity of the precipitation, e.g., including an indication of light, medium or heavy precipitation. The information may include whether the precipitation has a direct impact on the sensing operation, e.g., higher rainfall rates may degrade the received signal strengths and the range and/or accuracy of the sensing measurements.

In another example, the weather information may include humidity. The weather information may include different levels of humidity and fog effects. This weather information may include the humidity measurements, e.g., hygrometer readings or third-party service humidity information. The information may include a determination of whether the humidity has an impact on sensing operation, e.g., at a specific humidity level and/or fog, the sensing performance may be degraded (e.g., by attenuation due to atmospheric absorption).

In another example, the weather information may include weather turbulence. The information may include a determination that weather turbulence may distort the sensing operation, e.g., high wind and turbulence levels may refract the sensing signal and have an impact on doppler measurements. For example, the UE may determine that there is a level of wind debris that will have an impact on doppler or other measurements.

The weather information may also include temperature and pressure, including measurements that may have a negligible impact on the sensing operation but may have an impact on high-precision sensing measurements requirements. Additionally, the weather information may include information regarding active lightning storms, thunderstorms, and hurricanes.

In some examples, as part of an error handling procedure, the UE may send an error report to the network, e.g., via RRC, MAC-CE, UCI, which may include one or more of the following: an error report including information about the event trigger; a request for a different error and/or sensing configuration, e.g., if sensing is currently being performed with a set of RSs (e.g., using Conf_{A}) at high frequencies with higher attenuation levels (e.g., mmWave), then in response to sensing precipitation, the UE may determine that an event trigger is satisfied and may select an error handling procedure to request to switch to a configuration with lower frequency bands (e.g., sub-6 GHz); a request to switch to a new sensing configuration, e.g., the UE determines a new sensing configuration and autonomously switches to the new sensing configuration, either indicating to the network the configuration change or relying on the network to detect the change; or a request for termination, e.g., in response to determining that the device is incapable of performing the sensing operation (e.g., due to environmental conditions, low battery, CPU overload, or any other UE-performed measurements).

The error report (e.g., which may be transmitted as part of an error handling procedure) may include one or more of the following: hardware and software error measurements, e.g., low battery, full memory; environmental measurements, e.g., heaviness of precipitation, humidity/fog, weather turbulence (e.g., wind speeds), and/or nearby storms (e.g., lightning storms, thunderstorms, hurricanes) are affecting the UE beyond a certain threshold; or fallback to a default configuration, e.g., a received default configuration predetermined by the network.

In some embodiments, an event trigger may be satisfied because the UE fails to communicate the measurement report. In one example, the UE may send the measurement report and the TRP doesn't receive it. As part of an error handling procedure, the UE may be configured to send sensing information, e.g., sensing measurements reports and error event reports. The sensing information may be sent via UCI, MAC-CE, or RRC signaling using certain UL resources (e.g., PUSCH, PUCCH). Based on the initial sensing configuration, e.g., via RRC, the UE may select a particular error handling procedure, e.g., to report the sensing measurement report using different occurrences (based on periodic, aperiodic, or semi-persistent occurrences). In another example, as part of an error handling procedure, the UE may send multiple reports and cause the TRP to determine that one or more expected reports is missing (e.g., by identifying a missing sequence number) from among the multiple reports.

As part of an error handling procedure, the UE may cause the TRP to detect a missing report and transmit a request for retransmission, e.g., via DCI. Continuing the error handling procedure, the UE may receive the request and perform one or more of the actions provided as follows.

The UE may retransmit the missing report. For example, the UE may retransmit the report for a predefined number of times, e.g., at least once, where multiple retransmissions are separated by a predefined duration.

The UE may change a set of parameters in the current sensing configuration (e.g., the reporting intervals). The UE may change the set of parameters given a specific issue with the connection, e.g., interference. The UE may then indicate the change of the parameter to the TRP, e.g., via UCI, MAC-CE.

The UE may fall back to a default sensing configuration (e.g., a preconfigured default configuration), and may indicate the fallback to the network and/or rely on the network to blindly detect this change.

The UE may switch to a different sensing configuration to send the report. For example, if the current sensing configuration includes reporting based on Conf_{A}, the UE may switch to Conf_{B} and perform at least one of the following: indicate to the network the change in sensing configuration, e.g., indicate to the network that the UE has switch to Conf_B; and/or switch to another predefined or new sensing configuration, including causing the network to detect the change without receiving a direct indicator of the change.

In some embodiments, as part of determining that an event trigger is satisfied, the UE receives an uplink grant to send one or more sensing measurement reports, but cannot transmit for at least one of the following reasons: the UE has a higher priority data to be transmitted than the other sensing report(s); the sensing report is not ready upon receiving a grant, e.g., the UE is still processing and obtaining the sensing measurements and relevant information; a sensing report mismatch with the grant (e.g., size, time and availability mismatch) is identified, e.g., the sensing report includes more data than the granted uplink resources and/or the UE detects a number of sensing targets, wherein the sensing measurements and information exceed the granted uplink resources; multiple sensing measurement reports are generated and need to aggregate into a single transmission; an error in transmitting sensing reports is identified, e.g., requiring sensing reports (e.g., HARQ acknowledgments or upper layer error handlers) to be retransmitted; and/or the UE is performing a sensing operation that requires multiple reporting with low-latency requirements (e.g., tracking measurements with short periodicity).

In one example, as part of an error handling procedure, the UE uses a buffer to store the sensing information and/or one or more sensing reports. Upon receiving a new sensing report in the buffer, the UE may inform the network about the buffered sensing report/information. In this case, a buffered status report (BSR) is triggered via a control message (e.g., BSR MAC-CE) or a sensing specific BSR is triggered via a control message (e.g., sensing BSR).

To transmit the buffered sensing information as per the error handling procedure, the UE may request an uplink grant, e.g., the UE sends a scheduling request (SR) via a control channel, e.g., PUCCH. Upon receiving the grant via control message (e.g., via DCI), the UE sends the buffered sensing data (e.g., one or more sensing reports). In some cases, if the buffered sensing data exceeds the allocated resources in the uplink grant, the error handling procedure may also cause the UE to include a BSR or a sensing BSR in the transmission to inform the network about the remaining sensing data in the buffer. The UE may use buffering to minimize the latency of sensing reporting, e.g., to provide near-real time sensing information of a tracked object.

Herein, “sensing BSR” may be used interchangeably with “sensing specific BSR”. A sensing BSR may be used for informing the network about sensing-related buffer information. A sensing BSR may include one or more of the following: an indication (e.g., explicit or implicit) that the buffered information is related to sensing, e.g., using the dedicated channel group for sensing (e.g., a logical channel group (LCG) dedicated for handling sensing data); an indication (e.g., explicit or implicit) that the buffered information is related to sensing including the type of buffered information in the BSR; the type of buffering or BSR type (e.g., short BSR, long BSR, or truncated BSR) or the sensing specific BSR type, e.g., multi-BSR groups, where the UE can inform the network about multiple groups of buffered sensing information, grouped by sensing service; BSR timing type, e.g., regular, periodic, padding; periodicity of the BSR, e.g., periodicSensingBSR-Timer is set based on the sensing measurement being processed; and buffer size levels and extended size levels for sensing reports, e.g., defining a look-up table that may include different size levels. The sensing buffer size may depend on the sensing measurements, measurement granularity, sensing key performance indicators (KPIs), and/or quality of service.

The sensing BSR may be transmitted regularly, e.g., periodically, until the buffered sensing information is all sent. In cases where the retransmission time of sensing BSR (e.g., retxSensingBSR-Timer) has expired and the UE has a sensing report for transmission and doesn't receive a resource allocation in the network's response, the sensing BSR may be retransmitted.

In some embodiments, as part of the error handling procedure, the UE autonomously switches the sensing configuration and may indicate to the network the change in sensing configuration. However, the indication may not be received by the network, or the network doesn't detect the change in sensing configuration that occurred at the UE, causing the uplink grant resources to be insufficient for the new sensing measurement report transmission. The UE may determine that an event trigger has been satisfied based on the insufficient grant resources, and the UE may respond by selecting an error handling procedure for performing at least one of the following: buffering the sensing information; sending a sensing BSR to inform the network about the buffered sensing measurements, e.g., BSR MAC-CE; sending an SR, e.g., via PUCCH, to request an uplink grant to send the sensing BSR; indicating to the network to switch to the new configuration; and falling back to a predefined configuration.

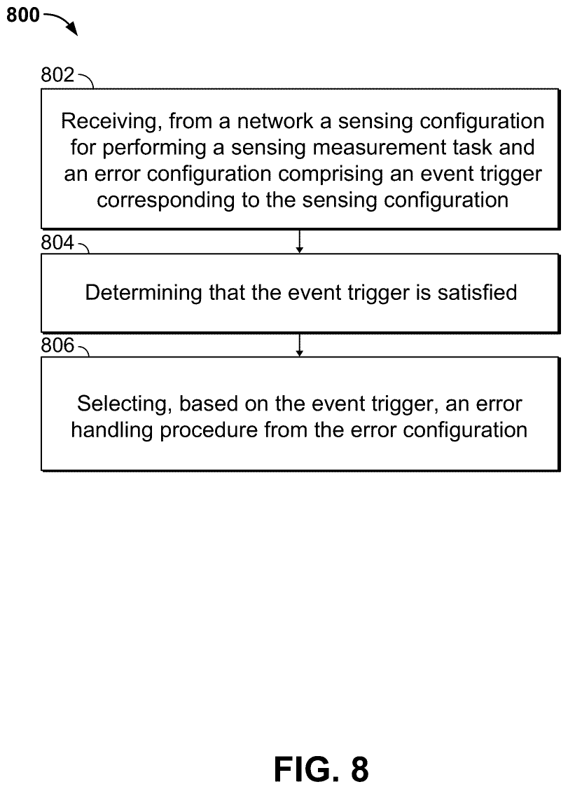

In certain representative embodiments, as shown in FIG. 8, a process 800 is performed by a WTRU (e.g., WTRUs 102 of FIGS. 1A-D) in connection with a TRP (e.g., any of the base stations 114 of FIG. 1A, the eNode-Bs 160 of FIG. 1C, or the gNBs 180 of FIG. 1D). For example, the process 800 includes the WTRU receiving, at step 802, from a TRP, a sensing configuration for performing a sensing measurement task and an error configuration including an event trigger corresponding to the sensing configuration. The process 800 also includes the WTRU determining, at step 804, that the event trigger is satisfied as well as the WTRU selecting, at step 806, based on the event trigger, an error handling procedure from the error configuration.

In some embodiments, the error trigger that the WTRU receives at step 802 from the TRP includes at least one of: missing information of the sensing configuration (e.g., the original configuration times out or the WTRU requests a new configuration from the TRP that is not received); a failure of the WTRU to comply with the sensing configuration; or a failure of the WTRU to communicate a measurement report based on the sensing measurement task to the TRP.

In some embodiments, the error trigger that the WTRU receives at step 802 from the TRP is based on a measurement of the sensing measurement task. For example, the measurement may include at least one of the following: an accuracy of sensing measurement (e.g., an accuracy of a range, velocity, and/or location measurement); a certainty of a sensing measurement (e.g., certainty of range, velocity, location); a confidence of a predicted measurement; a change in a channel response measurement; a measurement correlation; or an unidentified sensing profile. For another example, the process 800 may include the WTRU receiving a set of reference signals from the TRP, where the WTRU generates the measurement based on the set of reference signals, and the WTRU determines, at step 804, that the event trigger is satisfied based on the measurement.

In some embodiments, determining that the event trigger is satisfied may include determining that a particular condition (e.g., a weather condition, a configuration condition including a failure to receive or comply with a configuration, or a condition associated with the WTRU or with measurements based on received RSs) is satisfied. In some embodiments, determining that the event trigger is satisfied may include determining that a particular value (e.g., a value associated with the WTRU, an environment of the WTRU, or a sensing measurement based on received RSs) is above or below a threshold level.

In some embodiments, the determining at step 804 that the event trigger is satisfied is based on identifying a failure of the WTRU to comply with the sensing configuration. For example, the process 800 may include the WTRU obtaining measurements associated with the WTRU (e.g., device temperature, device memory information, device processing capacity availability, device buffer availability, battery level) or with environmental information of the WTRU (e.g., turbulence, precipitation, pressure), and the may WTRU determine that the WTRU is unable to comply with the sensing configuration based on the obtained measurements.

In some embodiments, the error handling procedure that the WTRU selects at step 806 includes at least one of the following: the WTRU sending an error report comprising information indicating the determined event trigger; the WTRU applying another sensing configuration based on the determined event trigger; the WTRU reverting to a default sensing configuration; the WTRU retransmitting a missing report; or the WTRU buffering information associated with the sensing measurement task.

“Network”, “gNode-B (gNB)”, and “transmission reception point (TRP)” may be used interchangeably in this disclosure.

“User equipment (UE)” and “wireless transmit/receive unit (WTRU)” may be used interchangeably in this disclosure.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶ 6 or means-plus-function claim format, and any claim without the terms “means for” is not so intended.

What is claimed is:

1. A method performed by a wireless transmit/receive unit (WTRU), the method comprising:
receiving, from a network:
a sensing configuration for performing a sensing measurement task, and
an error configuration comprising an event trigger corresponding to the sensing configuration;
determining that the event trigger is satisfied; and
selecting, based on the event trigger, an error handling procedure from the error configuration.

2. The method of claim 1, wherein the event trigger comprises at least one of:
missing information of the sensing configuration;
a failure of the WTRU to comply with the sensing configuration; or
a failure of the WTRU to communicate a measurement report based on the sensing measurement task to the network.

3. The method of claim 1, wherein determining the event trigger is satisfied is based on a failure of the WTRU to comply with the sensing configuration, the method further comprising:
obtaining measurements associated with the WTRU or with environmental information of the WTRU; and
determining that the WTRU is unable to comply with the sensing configuration based on the obtained measurements.

4. The method of claim 1, wherein the event trigger is based on a measurement of the sensing measurement task, wherein the measurement comprises at least one of:
an accuracy of a sensing measurement;
a certainty of a sensing measurement;
a confidence of a predicted measurement;
a change in a channel response measurement;
a measurement correlation; or
an unidentified sensing profile; and
the method further comprises:
receiving a set of reference signals from the network,
generating the measurement based on the set of reference signals, and
determining that the event trigger is satisfied based on the measurement.

5. The method of claim 1, wherein the error handling procedure comprises at least one of:
sending an error report comprising information indicating the determined event trigger;
applying another sensing configuration based on the determined event trigger;
reverting to a default sensing configuration;
retransmitting a missing report; or
buffering information associated with the sensing measurement task.

6. The method of claim 1, wherein the error handling procedure comprises buffering information associated with the sensing measurement task, the method further comprising sending a sensing buffer status report comprising at least one of:
an indication that the buffer status report is related to the sensing measurement task;
a type of buffering associated with the buffer status report;
a timing associated with the buffer status report; or
a periodicity associated with the buffer status report.

7. The method of claim 1, wherein the sensing configuration comprises a set of configurations, and each configuration of the set of configurations is associated with a respective set of targets, resources, or actions related to the sensing measurement task.

8. The method of claim 1, further comprising reporting error related information to the network, wherein the error related information comprises at least one of:
a retransmission configuration;
another sensing configuration; or
a default fallback configuration.

9. The method of claim 1, further comprising:
reporting information indicating the selected error handling procedure to the network; and
receiving, from the network, an updated sensing configuration for performing the sensing measurement task.

10. The method of claim 1, wherein the sensing configuration is a first sensing configuration, the method further comprising:
reporting information indicating the selected error handling procedure to the network, wherein the reporting information comprises an indication of a second sensing configuration;
receiving a negative acknowledgement associated with the second sensing configuration; and
receiving a third sensing configuration.

11. A wireless transmit/receive unit (WTRU) comprising:
a processor, and
a transceiver coupled to the processor, wherein the WTRU is configured to:
receive, from a network:
a sensing configuration for performing a sensing measurement task, and
an error configuration comprising an event trigger corresponding to the sensing configuration;
determine that the event trigger is satisfied; and
select, based on the event trigger, an error handling procedure from the error configuration.

12. The WTRU of claim 11, wherein the event trigger comprises at least one of:
missing information of the sensing configuration;
a failure of the WTRU to comply with the sensing configuration; or
a failure of the WTRU to communicate a measurement report based on the sensing measurement task to the network.

13. The WTRU of claim 11, wherein determining the event trigger is satisfied is based on a failure of the WTRU to comply with the sensing configuration, and wherein the WTRU is further configured to:
obtain measurements associated with the WTRU or with environmental information of the WTRU; and
determine that the WTRU is unable to comply with the sensing configuration based on the obtained measurements.

14. The WTRU of claim 11, wherein the event trigger is based on a measurement of the sensing measurement task, wherein the measurement comprises at least one of:
an accuracy of a sensing measurement;
a certainty of a sensing measurement;
a confidence of a predicted measurement;
a change in a channel response measurement;
a measurement correlation; or
an unidentified sensing profile; and
the WTRU is further configured to:
receive a set of reference signals from the network,
generate the measurement based on the set of reference signals, and
determine that the event trigger is satisfied based on the measurement.

15. The WTRU of claim 11, wherein the error handling procedure comprises at least one of:
sending an error report comprising information indicating the determined event trigger;
applying another sensing configuration based on the determined event trigger;
reverting to a default sensing configuration; or
buffering information associated with the sensing measurement task.

16. The WTRU of claim 11, wherein the error handling procedure comprises buffering information associated with the sensing measurement task, and wherein the WTRU is further configured to send a sensing buffer status report comprising at least one of:
an indication that the buffer status report is related to the sensing measurement task;
a type of buffering associated with the buffer status report;
a timing associated with the buffer status report;
retransmitting a missing report, or
a periodicity associated with the buffer status report.

17. The WTRU of claim 11, wherein the sensing configuration comprises a set of configurations, and each configuration of the set of configurations is associated with a respective set of targets, resources, or actions related to the sensing measurement task.

18. The WTRU of claim 11, wherein the WTRU is further configured to report error related information to the network, wherein the error related information comprises at least one of:
a retransmission configuration;
another sensing configuration; or
a default fallback configuration.

19. The WTRU of claim 11, wherein the WTRU is further configured to:
report information indicating the selected error handling procedure to the network; and
receive, from the network, an updated sensing configuration for performing the sensing measurement task.

20. The WTRU of claim 11, wherein the sensing configuration is a first sensing configuration, wherein the WTRU is further configured to:
report information indicating the selected error handling procedure to the network, wherein the reporting information comprises an indication of a second sensing configuration;
receive a negative acknowledgement associated with the second sensing configuration; and
receive a third sensing configuration.
